(19) United States
(12) Patent Application Publication
(10) Pub. No.: US 2026/0335881 A1
(43) Pub. Date: Oct. 29, 2026

(54) Scalable Microfluidic Electrochemical Cell

(71) Applicant: Government of the United States as represented by the Secretary of the Air Force, Wright-Patterson AFB, OH (US)

(72) Inventors: Thorsten Schroer, Palmdale, CA (US); Gregory LeCroy, Lancaster, CA (US); Miguel Aguila, Palmdale, CA (US); Mayra Rodriguez, Lancaster, CA (US); Tyler Downard, Phelan, CA (US); Brianna MacLeod, Lancaster, CA (US)

(21) Appl. No.: 19/188,049

(22) Filed: Apr. 24, 2025

(51) Int. Cl. B01L 3/00

(52) U.S. Cl. CPC B01L 3/502707; B01L 2200/025; B01L 2200/0689; B01L 2300/0645; B01L 2300/0883; B01L 2300/0887; B01L 2300/123

(57) ABSTRACT

The details, design, and methods for using a continuous flow microfluidic electrochemical cell are provided. The continuous flow microfluidic electrochemical cell has a plane parallel electrode geometry. The continuous flow microfluidic electrochemical cell can readily be scaled in divided and undivided cell configurations by stacking the parallel electrode plates while maintaining an interelectrode gap of 1 mm or less.

### RIGHTS OF THE GOVERNMENT

The invention described herein may be manufactured and used by or for the Government of the United States for all governmental purposes without the payment of any royalty.

### FIELD OF THE INVENTION

The present invention relates to scalable microfluidic electrochemical cells and a process of making and using same.

### BACKGROUND OF THE INVENTION

Due to the large electrode surface area to electrolyte volume ratio within microfluidic electrochemical cells, microfluidic electrochemical processes have accelerated reaction rates, higher yields, and improved selectivity in comparison to batch electrolysis. Due to the accelerated reaction rates, high fractional conversion can be achieved with a single pass of an electrolyte through the electrochemical cell, allowing for continuous flow operation. Unfortunately, adaptation of microfluidic electrochemistry has been limited for industrial processes owing to the absence of scalable microfluidic cells.

In order to achieve broader adaptation of microfluidic electrochemical processes in academia and in industry, a scalable and versatile microfluidic platform is required. As a result, Applicants disclose a design of a versatile parallel plate microfluidic cell that can be scaled by stacking electrode plates. The flexibility of such a design allows for the scaling of microfluidic electrochemical processes in an undivided or divided cell configuration.

### SUMMARY OF THE INVENTION

The details, design, and methods for using a continuous flow microfluidic electrochemical cell are provided. The continuous flow microfluidic electrochemical cell has a plane parallel electrode geometry. The continuous flow microfluidic electrochemical cell can readily be scaled in divided and undivided cell configurations by stacking the parallel electrode plates while maintaining an interelectrode gap of 10 mm or less.

In one non-limiting embodiment, a continuous flow microfluidic electrochemical cell is provided that comprises:
a) a first compression plate comprising at least one inlet;
b) a first reactor frame comprising at least one protruding inlet, the first reactor frame being disposed on the first compression plate, the at least one inlet protruding through the at least one inlet of the first compression plate;
c) a first seal comprising at least one inlet, the first seal being disposed on the first reactor frame and the at least one inlet of the first seal being positioned to correspond with the position of the at least one inlet of the reactor frame;
d) an electrochemical cell disposed on the first seal, the electrochemical cell comprising one or more electrode compartments, each electrode compartment comprising at least one inlet and at least one outlet, the one or more electrode compartments being disposed on the first seal and the one or more electrode compartments being arranged, with respect each other when there are at least two electrode compartments, in parallel and/or in series;
e) a second seal comprising at least one outlet, the second seal being disposed on the electrochemical cell and the at least one outlet of the second seal being positioned to correspond with the position of the at least one outlet of the electrochemical cell;
f) a second reactor frame comprising at least one protruding outlet, the second reactor frame being disposed on the second seal and positioned to align the at least one protruding outlet and the at least one outlet of the second seal; and
g) a second compression plate comprising at least one outlet, the second compression plate being disposed on the second reactor frame and positioned to allow the at least one protruding outlet to protrude through the at least one outlet of the second compression plate.

The continuous flow microfluidic electrochemical cell may comprise multiple electrode compartments, wherein the electrode compartments are in a stacked arrangement. The multiple electrode compartments in a stacked arrangement may be configured to direct the flow of electrolytes therethrough in parallel, in series, or in a combination of a parallel configuration and a series configuration. Each electrode compartment may comprise an anode compartment, a membrane, and a cathode compartment, with the membrane being disposed between the anode compartment and the cathode compartment. Examples of multiple electrode compartments being in a combination of a parallel configuration and a series configuration include an electrochemical cell in which the anode compartments are arranged in series and the cathode compartments are arranged in parallel, or vice versa.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

FIG. 1 is a perspective view of one embodiment of a microfluidic electrochemical cell according to the present invention.

FIG. 2 is an exploded perspective view of the microfluidic electrochemical cell of FIG. 1.

FIG. 3 is a plan view of an inlet compression plate for the microfluidic electrochemical cell.

FIG. 4 is a plan view of an outlet compression plate for the microfluidic electrochemical cell.

FIG. 5A is a side view of an inlet reactor flow frame for the microfluidic electrochemical cell.

FIG. 5B is a plan view of an inlet reactor flow frame for the microfluidic electrochemical cell.

FIG. 6A is a side view of an outlet reactor flow frame for the microfluidic electrochemical cell.

FIG. 6B is a plan view of an outlet reactor flow frame for the microfluidic electrochemical cell.

FIG. 7 is a plan view of an inlet seal for the microfluidic electrochemical cell.

FIG. 8 is a plan view of an outlet seal for the microfluidic electrochemical cell.

FIG. 9 is an exploded perspective view of a single electrode compartment of the microfluidic electrochemical cell of FIG. 1.

FIG. 10 is a plan view of an anode for the microfluidic electrochemical cell.

FIG. 11 is a plan view of a cathode for the microfluidic electrochemical cell.

FIG. 12A is a plan view of the channeled microfluidic flow laminae for the anode compartment of the microfluidic electrochemical cell of FIG. 1.

FIG. 12B is a plan view of the channeled microfluidic seal laminae for the anode compartment of the microfluidic electrochemical cell of FIG. 1.

FIG. 13A is a plan view of the channeled microfluidic flow laminae for the cathode compartment of the microfluidic electrochemical cell of FIG. 1.

FIG. 13B is a plan view of the channeled microfluidic seal laminae for the cathode compartment of the microfluidic electrochemical cell of FIG. 1.

FIG. 14 is a plan view of the ion permeable membrane of the microfluidic electrochemical cell of FIG. 1.

FIG. 15 is an exploded perspective view of a multi-stack microfluidic electrochemical cell in parallel configuration.

FIG. 16 is an exploded perspective view of the multiple electrode compartment assembled in parallel of the microfluidic electrochemical cell FIG. 15.

FIG. 17 is an exploded perspective view of a multi-stack microfluidic electrochemical cell in series configuration.

FIG. 18 is an exploded perspective view of the multiple electrode compartment assembled in series of the microfluidic electrochemical cell of FIG. 17.

FIG. 19 is a plan view of an anode of the microfluidic electrochemical cell in FIG. 17.

FIG. 20 is a plan view of a cathode of the microfluidic electrochemical cell in FIG. 17.

FIG. 21 is a schematic representation of the microfluidic electrochemical cell assembled with a hydraulic press.

FIG. 22 is a perspective showing the assembly of the tabbed microfluidic laminae.

FIG. 23 is an exploded perspective view of the multi-stack microfluidic electrochemical cell in hybrid series-parallel configuration.

FIG. 24 is an exploded perspective view of the multiple electrode compartment assembled in hybrid series-parallel of the microfluidic electrochemical cell of FIG. 23.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity of illustration.

### DETAILED DESCRIPTION OF THE INVENTION

### Definitions

Unless specifically stated otherwise, as used herein, the terms “a”, “an” and “the” mean “at least one”.

As used herein, the terms “include”, “includes” and “including” are meant to be non-limiting.

As used herein, the words “about,” “approximately,” or the like, when accompanying a numerical value, are to be construed as indicating a deviation as would be appreciated by one of ordinary skill in the art to operate satisfactorily for an intended purpose.

As used herein, the words “and/or” means, when referring to embodiments (for example an embodiment having elements A and/or B) that the embodiment may have element A alone, element B alone, or elements A and B taken together.

Microfluidics refers to a system that manipulates fluids in small channels with dimensions ranging from ten to hundreds of micrometers.

As used herein, a “microfluidic electrochemical cell” or more generally “electrochemical cell” refers to a flow-through electrochemical cell with interelectrode gaps between a lower end of 50 microns or 100 microns up to 10 mm, or any range therebetween. For example, in some cases, the interelectrode gap may be between 1-10 mm. In other cases, the interelectrode gap may be between a lower end of 50 microns or 100 microns up to 1 mm. The basic structural elements of a microfluidic electrochemical cell include a cell housing and electrode compartment(s). The most basic elements of the cell housing comprise a compression plate and a reactor frame containing an inlet and an outlet for an electrolyte solution. The basic structural elements of the electrode compartment comprise anode and cathode parallel electrode plates, channeled microfluidic laminae, and an ion-permeable membrane.

“Channeled microfluidic laminae” as used herein refers to a planar electrically insulating sheet of thicknesses of 1-10 mm or less with openings formed in the material to connect the inlet and outlet. The purpose of the channeled microfluidic laminae is to provide a hollow channeled path for the electrolyte to flow as it moves by the surface of the anode or cathode. The channeled microfluidic laminae also serve to separate the anode and cathode in space with a well-defined distance determined by the thickness or sum of thicknesses of the combined lamina. The distance between the anode and cathode is defined as the interelectrode gap. The channeled microfluidic laminae as used within the present invention also serves to hermitically seal the electrolyte within the electrochemical cell. The design of the channels within the microfluidic lamina may also be used to promote diffusion of the electrolytes within the anode and/or cathode compartments.

“Electrode compartment” or “electrode compartments” as used herein refers to the combined “anode compartment” and “cathode compartment” units within the microfluidic electrochemical cell. Generally, the electrode compartment is defined as a region of the microfluidic electrochemical cell in which reagents within the electrolyte are being oxidized or reduced by a potential applied to the cell. More specifically, oxidation of reagents within the electrolyte occurs within the anode compartment and reduction of the reagents within the electrolyte occurs within the cathode compartment. The confinement of the electrolyte within the anode compartment is achieved by the surface of the anode plate electrode, the channeled microfluidic laminae, and an ion-permeable membrane. The confinement of the electrolyte within the cathode compartment is achieved by the surface of the cathode plate electrode, channeled microfluidic laminae, and an ion-permeable membrane.

Herein, “electrolyte solution” refers to a solution containing ions, atoms, or molecules and is electrically conductive. Electrolyte solution will be used as a generic term to refer to the anode solution and/or cathode solution. “Anode solution” is defined as the electrolyte solution which will be oxidized at the surface of the anode and “cathode solution” is defined as the electrolyte solution which will be reduced at the surface of the cathode.

As used herein, the terms “series” and “parallel” flow refers to the manner in which an electrolyte or electrolyte solutions flows through the electrode compartments of the electrochemical cell. Familiar to someone skilled within the art, series flow refers to a solution flow profile in which all fluid components within the flow path are connected end-to-end to form a single path for the solution to travel. Parallel flow on the other hand refers to a flow configuration in which a solution branches so that the volume of the solution divides evenly through each of the available solution paths.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The present invention relates to scalable microfluidic electrochemical cells and a process of making and using same.

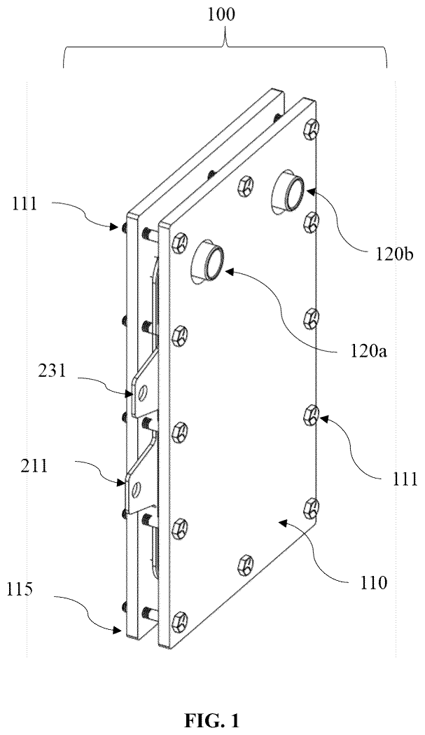

FIG. 1 shows one non-limiting embodiment of a microfluidic electrochemical cell 100 comprising a single electrode compartment. The microfluidic electrochemical cell 100 comprises an inlet (or “first”) compression plate 110, an outlet (or “second”) compression plate 115, fasteners 111, an anode 211, a cathode 231, a threaded anode inlet 120a, and a threaded cathode inlet 120b. The components of the electrochemical cell 100 can be joined together with fasteners, 111, with each fastener applying an axial compressive force along the compression plates, 110 and 115. The compressive force is uniformly distributed over the internal components of the electrochemical cell, creating a hermitic seal. An anolyte and a catholyte are introduced into the microfluidic electrochemical cell through the threaded electrolyte inlets, 120a and 120b of reactor frame 120, respectively.

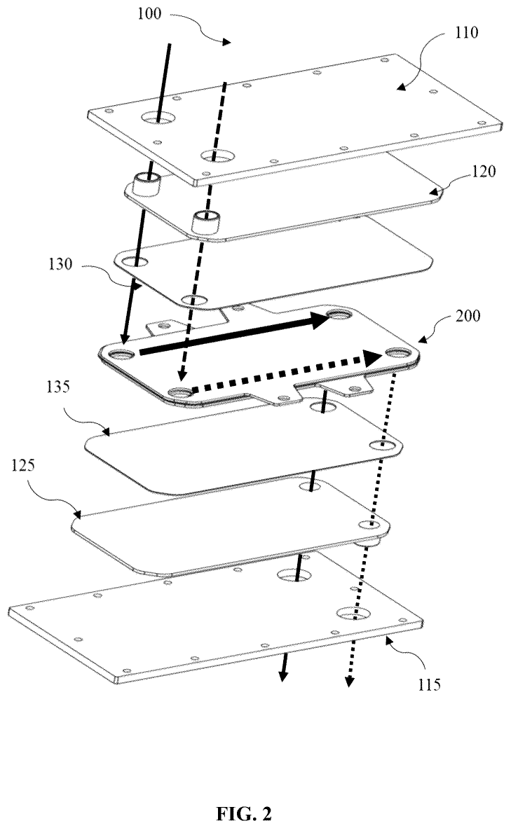

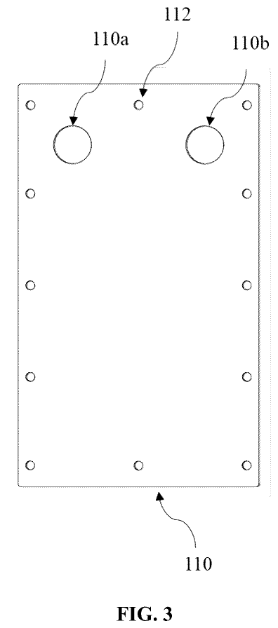

FIG. 2 shows the assembly of the components of the microfluidic electrochemical cell 100 shown in FIG. 1. FIG. 2 shows the microfluidic electrochemical cell 100 comprises a cell housing and an electrode compartment 200. The cell housing comprises the components other than the electrode compartment 200. These components of the cell housing comprise the inlet compression plate 110, an inlet (or “first”) reactor frame 120, an inlet (or “first”) seal 130, an outlet (or “second”) seal 135, an outlet (or “second”) reactor frame 125, and the outlet compression plate 115. The individual components of the cell housing are shown in FIGS. 3-8.

FIG. 3 shows the inlet compression plate 110. The inlet compression plate 110 has a plurality of through-holes therein denoted as anode inlet port 110a, cathode inlet port 110b, and fastener holes 112.

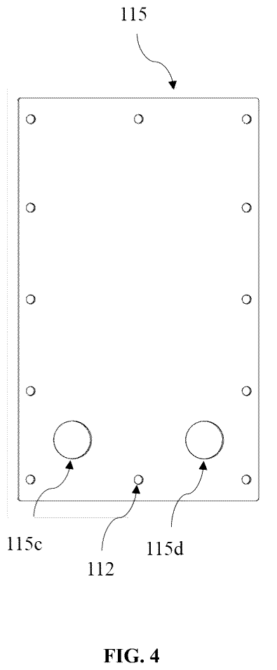

FIG. 4 shows the outlet compression plate 115. The outlet compression plate 115 has a plurality of through-holes therein denoted as the anode outlet port 115c, cathode outlet port 115d, and fastener holes 112. The microfluidic electrochemical cell 100 components may be assembled between the inlet and outlet compression plates 110 and 115, which are fastened together to provide axial compression with fasteners 111 through fastener holes 112.

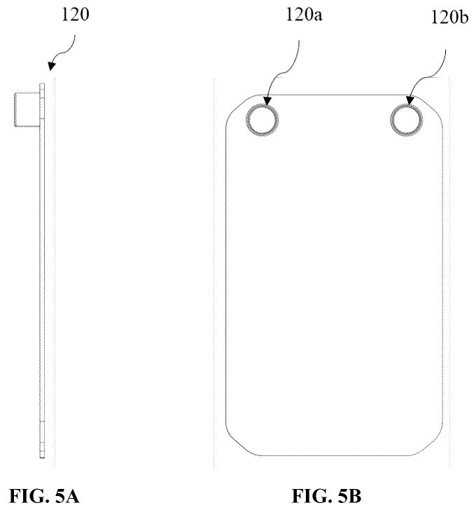

FIGS. 5A and 5B show the inlet reactor frame 120. The inlet reactor frame 120 comprises a protruding threaded anode inlet port 120a and a protruding cathode inlet port 120b. The protruding threaded anode inlet port 120a and protruding cathode inlet port 120b mate with the inlet compression plate inlet ports 110a and 110b, respectively. The threaded electrolyte inlets may be machined to accommodate standard fittings, such as National Pipe Taper (NPT) fittings, SWAGELOK® weld fittings, or Army-Navy (AN) fittings.

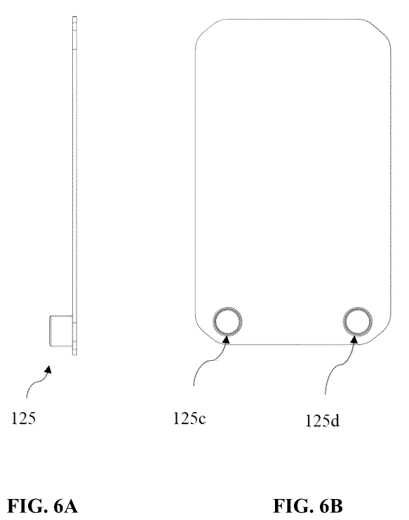

FIGS. 6A and 6B show the outlet reactor frame 125. The outlet reactor frame 125 comprises a protruding threaded anode outlet port 125c and a protruding threaded cathode outlet port 125d. The protruding threaded anode outlet port 125c and protruding threaded cathode outlet port 125d mate with the outlet compression plate outlet ports 115c and 115d, respectively.

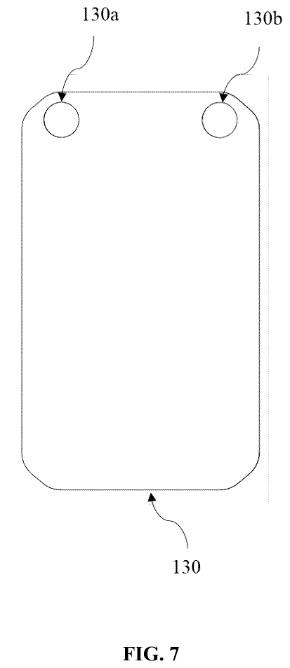

FIG. 7 shows the inlet seal 130. The inlet seal 130 has an anode inlet port 130a and a cathode inlet port 130b formed therein. The anode inlet port 130a and cathode inlet port 130b mate with threaded anode inlet port 120a and cathode inlet port 120b, respectively.

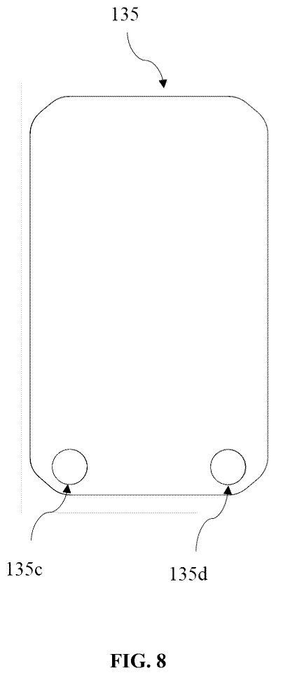

FIG. 8 shows the outlet seal 135. The outlet seal 135 has an anode outlet port 135c and a cathode outlet port 135d formed therein. The anode outlet port 135c and cathode outlet port 135d mate with threaded anode outlet port 125c and threaded cathode outlet port 125d, respectively.

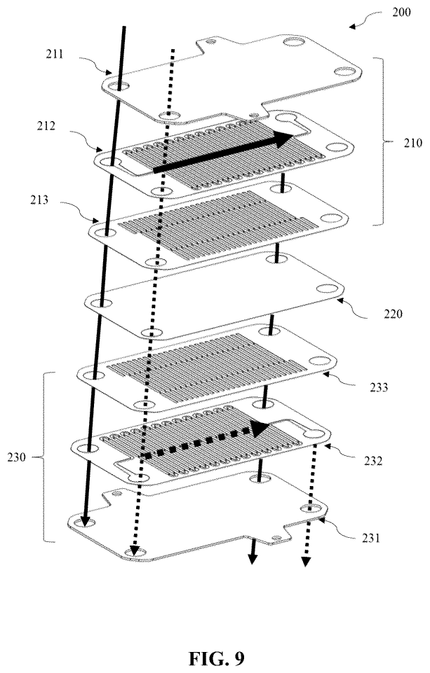

FIG. 9 shows the assembly of the electrode compartment 200 shown in FIG. 2. The electrode compartment 200 comprises the anode compartment 210, ion exchange membrane (or “ion permeable membrane”) 220, and cathode compartment 230. The anode compartment 210 comprises an anode 211, an anode channeled microfluidic flow laminae 212, and an anode channeled microfluidic seal laminae 213. The cathode compartment 230 comprises a cathode channeled microfluidic seal laminae 233, a cathode channeled microfluidic flow laminae 232, and a cathode 231. The ion-permeable membrane 220 is shared between the anode compartment 210 and the cathode compartment 230 to allow for ion conductivity between the two compartments.

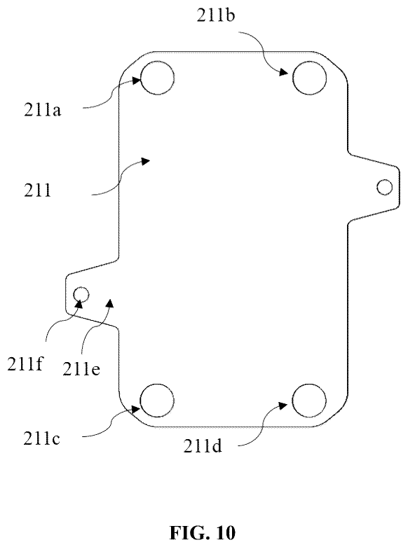

FIG. 10 shows the anode 211. The anode 211 comprises an anode inlet port 211a and a cathode inlet port 211b. The anode 211 is disposed onto inlet seal 130 (shown in FIG. 2). The anode inlet port 211a and a cathode inlet port 211b align with anode inlet port 130a and cathode inlet port 130b of the inlet seal 130, respectively. The anode 211 may also have an anode outlet port 211c and a cathode outlet port 211d formed therein. The anode inlet port 211a, the cathode inlet port 211b, the anode outlet port 211c, and the cathode outlet port 211d may all be in the form of openings formed in the anode 211. The anode 211 also comprises an electrode tab 211e, and an electrode tab connection port 211f, for connecting the anode 211 to a power source for electrochemical processes. The electrode tab connection port 211f may be in the form of an opening in the electrode tab 211e.

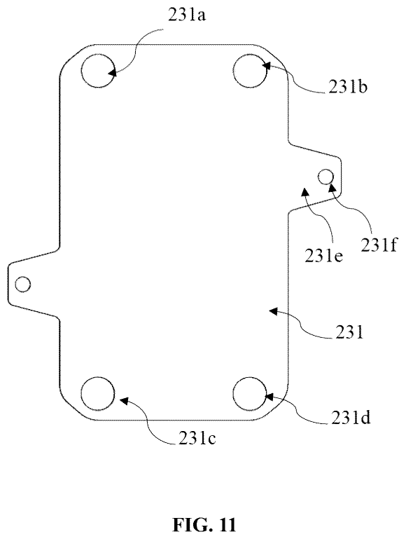

FIG. 11 shows the cathode 231. The cathode 231 comprises an anode inlet port 231a and a cathode inlet port 231b. The cathode 231 may comprise an anode outlet port 231c and cathode outlet port 231d, which are disposed onto the outlet seal 135 (shown in FIG. 2). The anode inlet port 231a and a cathode inlet port 231b align with anode outlet port 135c and cathode outlet port 135d of the outlet seal 135, respectively. The anode inlet port 231a, the cathode inlet port 231b, the anode outlet port 231c, and the cathode outlet port 231d may all be in form of openings formed in the cathode 231. The cathode 231 also comprises an electrode tab 231e, and an electrode tab connection port 231f, for connecting the cathode 231 to a power source for electrochemical processes. The electrode tab connection port 231f may be in the form of an opening in the electrode tab 231e.

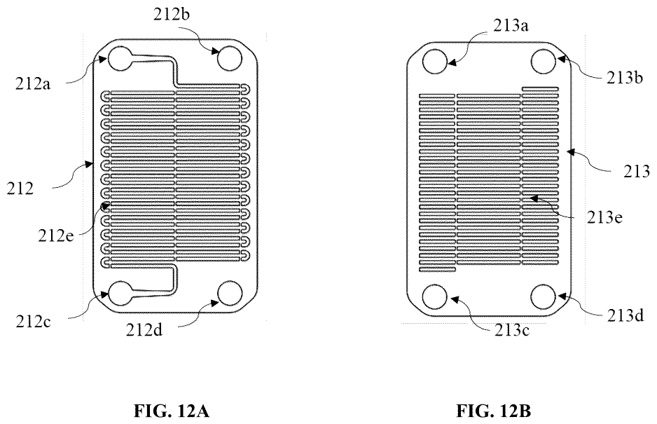

FIG. 12A shows the anode channeled microfluidic flow laminae 212. The anode channeled microfluidic flow laminae 212 comprises an anolyte inlet channel 212a, a catholyte inlet passthrough port 212b, an anolyte outlet channel 212c, and a catholyte outlet passthrough port 212d. The “inlet channels” comprise a shallow circular well with a channel that leads to the microfluid channels. The “passthrough ports” in any of the components described herein may be in the form of openings formed in the component. The anode channeled microfluidic flow laminae may have tabbed microfluidic channels 212e.

FIG. 12B shows the anode channeled microfluidic seal laminae 213. The anode channeled microfluidic seal laminae 213 comprises an anolyte inlet passthrough port 213a, a catholyte inlet passthrough port 213b, an anolyte outlet passthrough port 213c, and a catholyte outlet passthrough port 213d. The anode channeled microfluidic seal laminae 213 may also have tabbed microfluidic channels 213e, which are complementary to the tabbed microfluidic channels 212e.

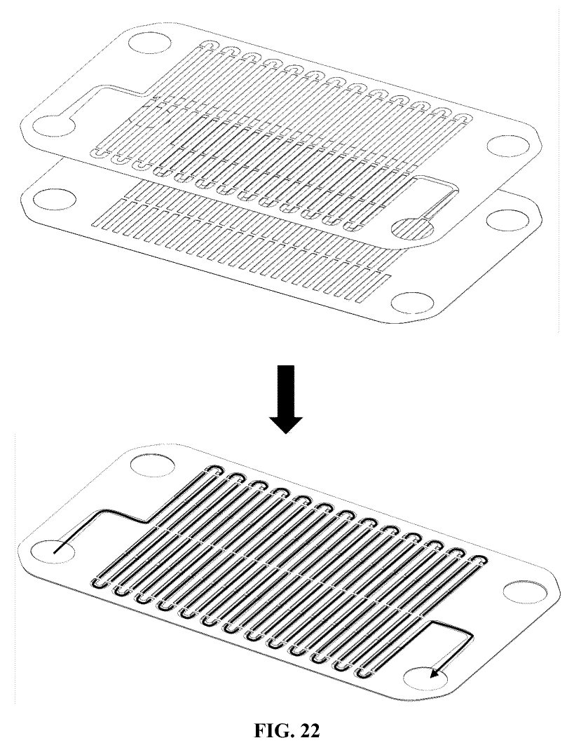

FIG. 22 shows the assembly of the tabbed microfluidic laminae to form the tabbed microfluidic channels. The tabbed microfluidic laminae have channels formed (e.g., machined) into them to allow an electrolyte to flow through the channels. Within each channel, there are support tabs, which are small pieces of material left in place to help maintain the structural integrity of the lamina and channels. These tabs partially block the channel in each lamina, but they are offset between the laminae. When the laminae are stacked to form a complete channel as shown in the lower portion of FIG. 22, the fluid can flow unimpeded through the channels because it flows under the tab of one lamina or over the tab of another lamina. The offset design of the tabs ensures that even though each channel within a lamina has obstructions, the combined laminae provide a continuous (e.g., sinusoidal or serpentine) fluid path. The complementary channels and tabs allow the electrolyte to flow unimpeded through the cell.

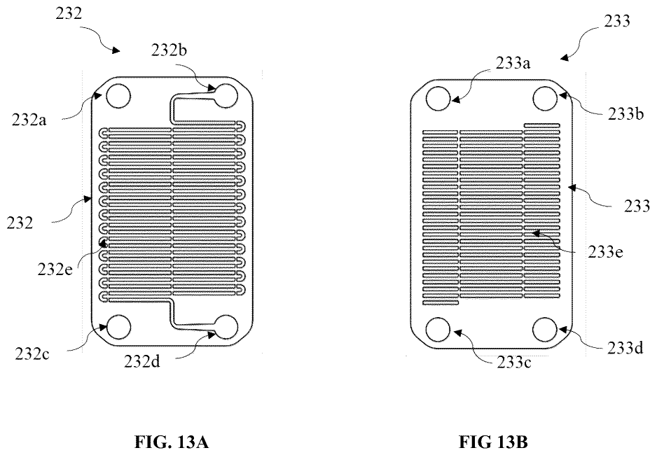

FIG. 13A shows the cathode channeled microfluidic flow laminae 232. The cathode channeled microfluidic flow laminae 232 comprises an anolyte inlet passthrough port 232a, a cathode inlet channel 232b, an anolyte outlet passthrough port 232c, and a catholyte outlet channel 232d. The outlet channels, such as catholyte outlet channel 232d, are similar to the inlet channels in that they comprise a shallow circular well with a channel that leads to the microfluid channels. The anode channeled microfluidic flow laminae 232 may have tabbed microfluidic channels 232e.

FIG. 13B shows the cathode channeled microfluidic seal laminae 233. The cathode channeled microfluidic seal laminae 233 comprises an anolyte inlet passthrough port 233a, a catholyte inlet passthrough port 233b, an anolyte outlet passthrough port 233c, and a catholyte outlet passthrough port 233d. The cathode channeled microfluidic seal laminae 233 may also have tabbed microfluidic channels 233e, which are complementary to the tabbed microfluidic channels 232e. The complementary channels and tabs allow for the catholyte to flow unimpeded through the cell.

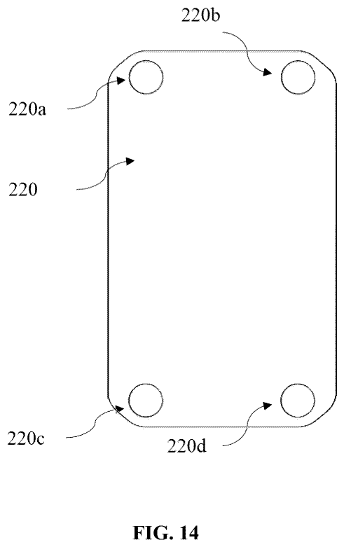

FIG. 14 shows the ion-permeable membrane 220. The ion-permeable membrane 220 comprises an anolyte inlet passthrough port 220a, a catholyte inlet passthrough port 220b, an anolyte outlet passthrough port 220c, and a catholyte outlet passthrough port 220d.

The microfluidic electrochemical cell 100 shown in FIGS. 1 and 2 can be assembled in any suitable manner. The assembly of the cell housing comprising the inlet compression plate 110, inlet reactor frame 120, inlet seal 130, outlet seal 135, outlet reactor frame 125, and outlet compression plate 115 is as follows. As shown in FIG. 2, the inlet compression plate 110 is disposed onto inlet reactor frame 120, such that threaded anode inlet port 120a and threaded cathode inlet port 120b protrude through anode inlet port 110a and cathode inlet port 110b of the inlet compression plate 110, respectively. The inlet seal 130 may be disposed onto reactor frame 120, such that anode inlet port 130a and cathode inlet port 130b align with anode inlet port 120a and cathode inlet port 120b of inlet reactor frame 120, respectively. The electrode compartment 200 (the assembly of which is described below) is disposed onto the inlet seal 130, such that anode inlet port 211a and cathode inlet port 211b of anode 211 align with anode inlet port 130a and cathode inlet port 130b of the inlet seal 130, respectively. The outlet seal 135 is disposed onto electrode compartment 200 such that anode outlet port 135c and cathode outlet port 135d are aligned with anode outlet port 231c and cathode outlet port 231d of the cathode 231, respectively. The outlet reactor frame 125 is disposed onto outlet seal 135 such that threaded anode outlet port 125c and threaded cathode outlet port 125d aligns with anode outlet port 135c and cathode outlet port 135d, respectively. The outlet compression plate 115 is disposed onto outlet reactor frame 125 such that threaded anode outlet port 125c and threaded cathode outlet port 125d protrudes through anode outlet port 115c and cathode outlet port 115d of the outlet compression plate 115, respectively. The fastener holes 112 of the inlet compression plate 110 and outlet compression plate 115 are aligned to allow fasteners 111 to protrude through the compression plates and to apply an axially compressive force to seal the microfluidic electrochemical cell.

The assembly of the electrode compartment 200 shown in FIG. 9 is as follows. The electrode compartment 200 comprises anode 211, anode channeled microfluidic flow laminae 212, anode channeled microfluidic seal laminae 213, ion-permeable membrane 220, cathode channeled microfluidic seal laminae 233, cathode channeled microfluidic flow 232, and cathode 231. Anode 211 is disposed onto anode channeled microfluidic flow laminae 212, such that anode inlet port 211a, cathode inlet port 211b, anode outlet port 211c, and cathode outlet port 211d align with anolyte inlet channel 212a, catholyte inlet passthrough port 212b, anolyte outlet channel 212c, and catholyte outlet passthrough port 212d, respectively. Anode channeled microfluidic flow laminae 212 is disposed onto the anode channeled microfluidic seal laminae 213, such that anolyte inlet channel 212a, catholyte inlet passthrough port 212b, anolyte outlet channel 212c, and catholyte outlet passthrough port 212d align with anolyte inlet passthrough port 213a, catholyte inlet passthrough port 213b, anolyte outlet passthrough port 213c, catholyte outlet passthrough port 213d, respectively. The anode channeled microfluidic seal laminae 213 is disposed onto ion-permeable membrane 220 such that anolyte inlet passthrough port 213a, catholyte inlet passthrough port 213b, anolyte outlet passthrough port 213c, catholyte outlet passthrough port 213d align with the anolyte inlet passthrough port 220a, catholyte inlet passthrough port 220b, anolyte outlet passthrough port 220c, and catholyte outlet passthrough port 220d, respectively. The ion-permeable membrane 220 is disposed onto cathode channel microfluidic seal laminae 233 such that anolyte inlet passthrough port 220a, catholyte inlet passthrough port 220b, anolyte outlet passthrough port 220c, and catholyte outlet passthrough port 220d align with the anolyte inlet passthrough port 233a, catholyte inlet passthrough port 233b, anolyte outlet passthrough port 233c, catholyte outlet passthrough port 233d, respectively. The cathode channeled microfluidic seal laminae 233 is disposed onto cathode channeled microfluidic flow laminae 232 such that anolyte inlet passthrough port 233a, catholyte inlet passthrough port 233b, anolyte outlet passthrough port 233c, catholyte outlet passthrough port 233d align with anolyte inlet passthrough port 232a, catholyte inlet channel 232b, anolyte outlet passthrough port 232c, catholyte outlet channel 232d, respectively. The cathode channeled microfluidic flow laminae 232 is disposed onto cathode 231 such that anolyte inlet passthrough port 232a, catholyte inlet channel 232b, anolyte outlet passthrough port 232c, catholyte outlet channel 232d align with the anode inlet port 231a, cathode inlet port 231b, anode outlet port 231c, and cathode outlet port 231d, respectively.

The cell operation, including the fluid path through the electrochemical cell 100 shown in FIGS. 1, 2, and 9 is as follows. The anolyte populates the anode compartment 210 (shown in FIG. 9) through the threaded anode inlet port 120a of the reactor frame 120. The anolyte fills the cavity generated by openings 211a of anode 211, anolyte inlet channel 212a and anolyte inlet passthrough port 213a of anode channeled microfluidic laminae 212/213, anolyte inlet passthrough port 220a of ion-permeable membrane 220, anolyte inlet passthrough ports 233a and 232a of cathode channeled microfluidic laminae 233/232, and anode inlet port 231a of cathode 231. The catholyte populates the cathode compartment 230 through the threaded cathode inlets port 120b of the reactor frame 120. The catholyte fills the cavity generated by catholyte inlet passthrough port 211b in anode 211, catholyte inlet passthrough ports 212b and 213b of anode channeled microfluidic laminae 212/213, catholyte inlet passthrough port 220b of ion-permeable membrane 220, catholyte inlet passthrough port 233b and catholyte inlet channel 232b of cathode channeled microfluidic laminae 233/232, and cathode inlet port 231b of cathode 231.

Within the anode compartment, 210, the anolyte flows through the anode compartment 210 through the anolyte inlet channel 212a of the channeled microfluidic fluidic laminae 212. The anode solution proceeds through the anode compartment 210, confined by the walls of the channeled microfluidic lamina 212 and 213, the anode 211, and the ion permeable membrane 220. Once the anolyte flows through the anode compartment 210 and reaches the anolyte outlet channel 212c of the channeled microfluidic laminae 212, it exits the cell through anolyte outlet passthrough ports 213c/220c/233c/232c, and anode outlet port 231c of anode channeled microfluidic seal laminae 213, ion-permeable membrane 220, cathode channeled microfluidic seal laminae 233/232, and cathode 231, respectively. The anolyte proceeds to exit electrochemical cell through the anode outlet port 125c of the reactor frame 125.

Concurrently, within the cathode compartment, 230, the catholyte flows through the cathode compartment through the catholyte inlet channel 232b of the channeled microfluidic fluidic laminae 232. The catholyte proceeds through the cathode compartment 230, confined by the walls of the channeled microfluidic lamina 232/233, the cathode 231, and the ion permeable membrane 220. Once the catholyte flows through the anode compartment and reaches the catholyte outlet channel 232d of the channeled microfluidic laminae 232, it exits the cell through the cathode outlet port 231d of cathode 231. The anolyte proceeds to exit electrochemical cell through the cathode outlet port 125d of the reactor frame 125.

There are numerous, non-limiting embodiments of the invention. All embodiments, even if they are only described as being “embodiments” of the invention, are intended to be non-limiting (that is, there may be other embodiments in addition to these), unless they are expressly described as limiting the scope of the invention. Any of the embodiments described herein can also be combined with any other embodiments in any manner to form still other embodiments.

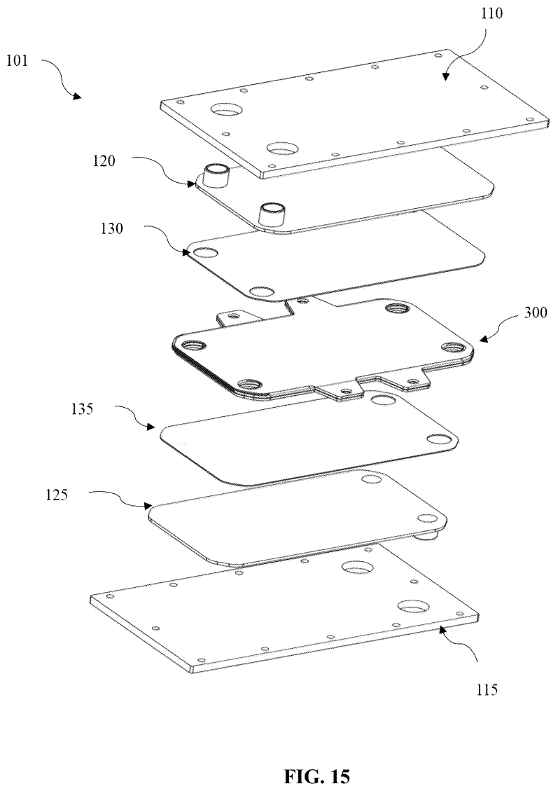

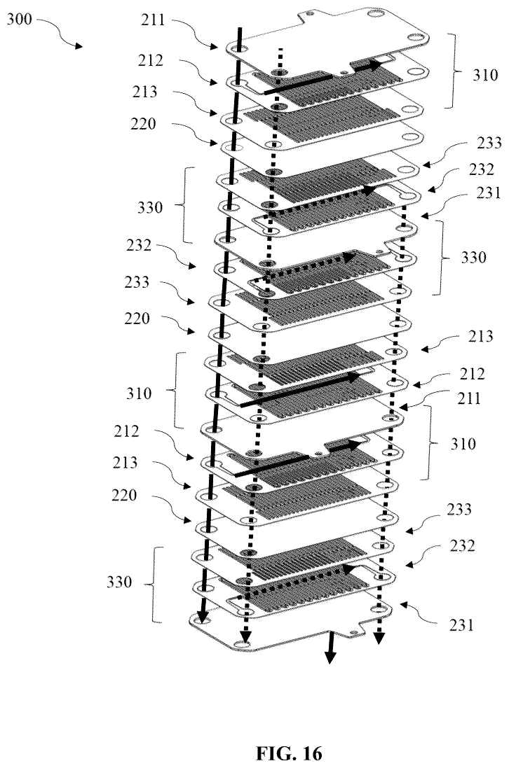

FIGS. 15 and 16 show another embodiment of the present invention. In this embodiment, the microfluidic electrochemical cell 101 can comprise multiple electrode compartments. There can be any suitable number of electrode compartments, from one to 20, or more. By way of a nonlimiting example, FIG. 15 shows a scaled microfluidic electrochemical cell 101, comprising the cell housing and a multi-compartment electrode compartment 300 comprising multiple assembled electrode compartments. The multi-compartment microfluidic electrochemical cell 101, comprises an inlet compression plate 110, an outlet compression plate 115, an inlet reactor frame 120, an outlet reactor frame 125, an inlet elastomeric seal 130, an outlet elastomeric seal 135 and a multi-compartment electrode compartment 300 comprising multiple stacked electrode compartments in parallel. In this configuration, the components of the cell housing (110/115, 120/125, and 130/135) are unchanged from the previous embodiment.

FIG. 16 shows the stacked electrode compartments of the multi-compartment electrode compartment 300 of the microfluidic electrochemical cell 101 shown in FIG. 15. The stacked electrode compartments comprise three anode compartments 310 and three cathode compartments 330. The anode compartments 310 comprise anodes 211 and an anode channeled microfluidic laminae 212/213. The cathode compartments 330 comprise a cathode 231 and an cathode channeled microfluidic laminae 232/233. The ion-permeable membrane 220 is shared by the anode compartment 310 and cathode compartment 330 to allow for ion conductivity between the compartments. In this embodiment, the second instance of anode 211 is shared by two anode compartments 310, and the second instance of cathode 231 is shared by two cathode compartments 330. Stated in a different manner, this cell configuration has two anodes 211 and two cathodes 231 yet has three anode compartments 310, and three cathode compartments 330.

The operation of the electrochemical cell 101 shown in FIGS. 15 and 16, including the electrolyte solution flow paths is as follows. Referring to the electrode compartment 300 of FIG. 15 and FIG. 16, the anolyte populates the anode compartment through the threaded anode inlets port 120a of the reactor frame 120. The anolyte fills the cavity generated by anolyte inlet channel 211a in anode 211, anolyte inlet channel 212a and anolyte inlet passthrough port 213a of anode channeled microfluidic laminae 212/213, anolyte inlet passthrough port 220a of ion-permeable membrane 220, anolyte inlet passthrough ports 233a and 232a of cathode channeled microfluidic laminae 233/232, and anode inlet port 231a of cathode 231. The anolyte populates the defined cavity within all electrode compartments within stack 300, from FIG. 15 and FIG. 16. The catholyte populates the cathode compartment through the threaded cathode inlet port 120b of the reactor frame 120. The catholyte fills the cavity generated by openings 211b in anode 211, catholyte inlet passthrough ports 212b and 213b of anode channeled microfluidic laminae 212/213, catholyte inlet passthrough port 220b of ion-permeable membrane 220, catholyte inlet passthrough port 233b and catholyte inlet channel 232b of cathode channeled microfluidic laminae 233/232, and cathode inlet port 231b of cathode 231. The catholyte populates the defined cavity within all electrode compartments within stack 300, from FIGS. 15 and 16.

Within the anode compartments, 310, the anolyte flows in parallel through all anode compartments through the anolyte inlet channel 212a of the channeled microfluidic fluidic laminae 212. The anolyte proceeds through the anode compartment, confined by the walls of the channeled microfluidic lamina 212/213, the anode 211, and the ion permeable membrane 220. Once the anolyte flows through the anode compartment and reaches the outlet channel of the channeled microfluidic laminae 212/213, it exits the cell through ports made by anolyte outlet channel 212c and anolyte outlet passthrough ports 213c/232c/233c of channeled microfluidic laminae 212/213/232/233, 220c and of ion-permeable membrane 220, anode outlet port 211c of anode 211, and anode outlet port 231c of cathode 231. The anolyte proceeds to exit electrochemical cell through the anode outlet port 125c of the reactor frame 125.

Concurrently and in series, within the cathode compartment, 330, the catholyte flows through the cathode compartments through the catholyte inlet channel 232b of the channeled microfluidic fluidic laminae 232. The catholyte proceeds through the cathode compartment, confined by the walls of the channeled microfluidic lamina 232/233, the cathode 231, and the ion permeable membrane 220. Once the catholyte flows through the cathode compartment and reaches the catholyte outlet channel 232d of the channeled microfluidic laminae 232, it exits the cell through catholyte outlet passthrough port 212d and catholyte outlet passthrough ports 213d/231d/232d of channeled microfluidic laminae 212/213/232/233, 220d and of ion permeable membrane 220, cathode outlet port 211d of anode 211, and cathode outlet port 231d of cathode 231. The catholyte proceeds to exit electrochemical cell through the cathode outlet port 125d of the reactor frame 125.

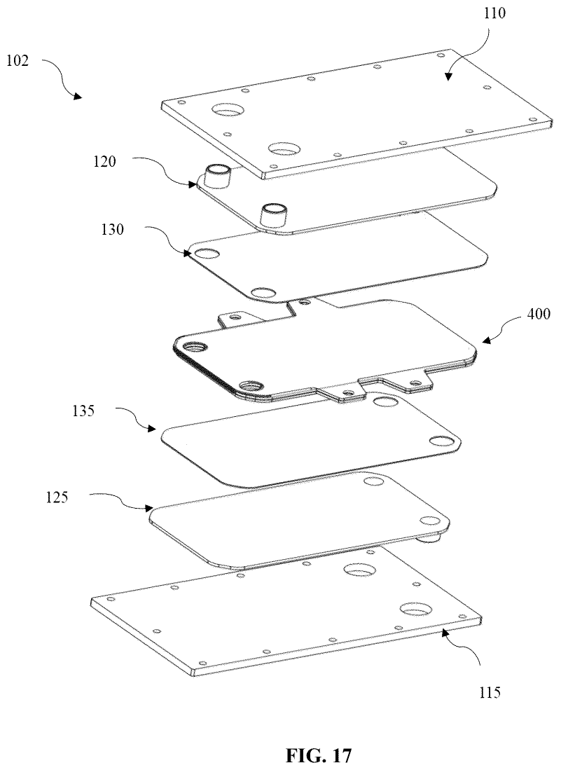

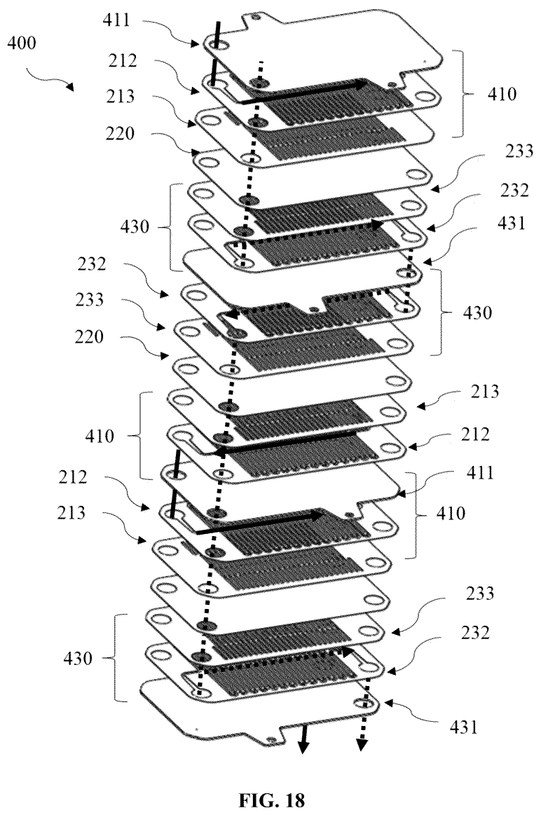

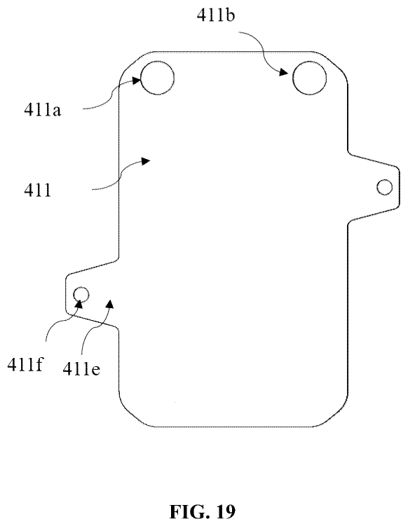

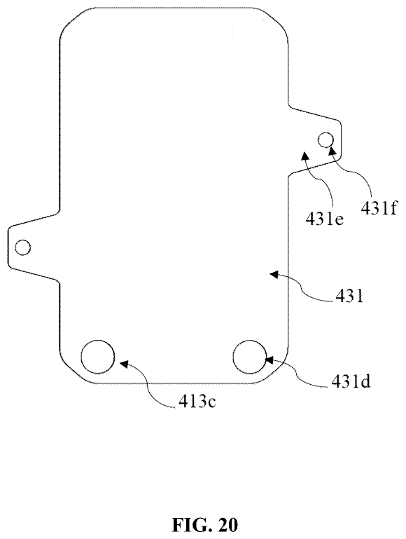

FIG. 17 shows another embodiment of the present invention in which the electrolyte solution flows through the electrochemical cell 102 in a series flow path. The multi-compartment microfluidic electrochemical cell 102 comprises an inlet compression plate 110, an outlet compression plate 115, an inlet reactor frame 120, an outlet reactor frame 125, an inlet elastomeric seal 130, an outlet elastomeric seal 135, and multiple stacked electrode compartments in series 400. FIG. 18 shows the electrode compartment 400 of the microfluidic electrochemical cell of FIG. 17 with three electrode compartments (in series) comprising: anode compartments 410, anodes 411, anode channeled microfluidic flow lamina 212, anode channeled microfluidic seal lamina 213, ion-exchange membrane 220, cathode compartments 430, cathodes 431, cathode channeled microfluidic seal lamina 232, and cathode channeled microfluidic seal lamina 233. The difference between this embodiment and the previous embodiment is the design of the openings formed within the anode 411 and cathode 431 electrode plates, as shown in FIG. 19 and FIG. 20, respectively. FIG. 19 is a top view of anode 411 showing anode inlet port 411a, cathode inlet port 411b, electrode tab 411e, and electrode tab connection port 411f. FIG. 20 shows the cathode 431 having anode outlet port 431c, cathode outlet port 431d, electrode tab 431e, and electrode tab connection port 431f. By having openings on one side of the electrodes, the electrolyte solutions are forced to flow through anode compartments 410 and cathode compartments 430 of the cell in two uninterrupted flow paths. This results in the electrolytes meandering through each electrode compartment sequentially until exiting the electrochemical cell through the electrolyte outlet 125c/125d of the reactor frame 125 shown in FIG. 17.

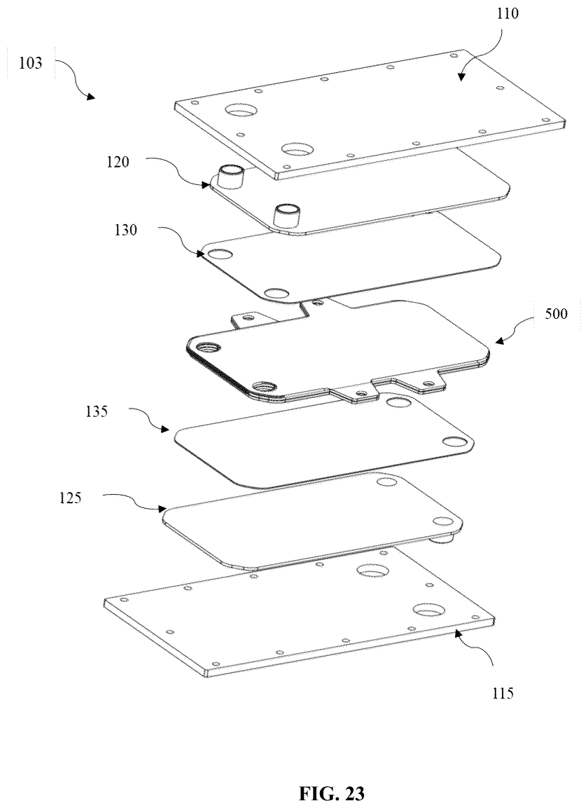

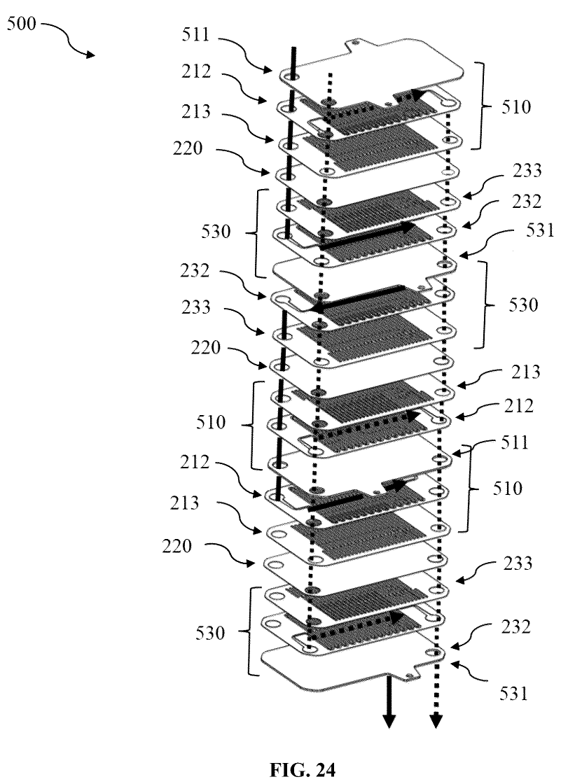

FIG. 23 shows another embodiment of the present invention in which the electrolyte solution flows through the electrochemical cell 103 in a hybrid series-parallel flow path. The multi-compartment microfluidic electrochemical cell 103 comprises an inlet compression plate 110, an outlet compression plate 115, an inlet reactor frame 120, an outlet reactor frame 125, an inlet elastomeric seal 130, an outlet elastomeric seal 135, and multiple stacked electrode compartments in hybrid series-parallel flow configuration 500. FIG. 24 shows the electrode compartment 500 of the microfluidic electrochemical cell of FIG. 23 with three anode compartments in series and three cathode compartments in parallel with the compartments comprising: anode compartments 510, anodes 511, anode channeled microfluidic flow lamina 212, anode channeled microfluidic seal lamina 213, ion-exchange membrane 220, cathode compartments 530, cathodes 531, cathode channeled microfluidic seal lamina 232, and cathode channeled microfluidic seal lamina 233.

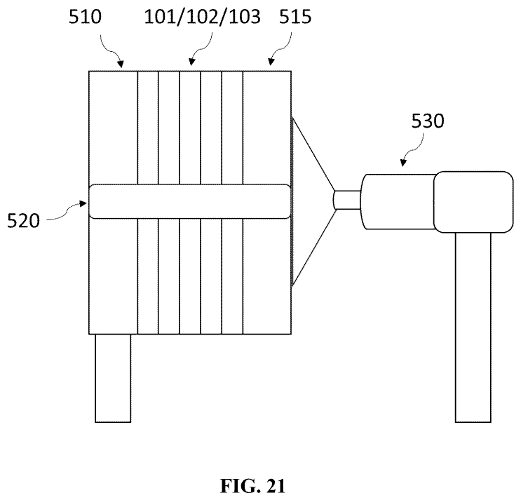

FIG. 21 shows that in another embodiment (or in any of the embodiments described herein), the microfluidic electrochemical cell 100, 101, or 102 may be assembled with a filter-press assembly instead of with fasteners. As shown in FIG. 21, the electrochemical cell is sealed by axial force from a hydraulic press comprising compression end plates 510 and 515, beam 520, and hydraulic jack 530.

The material composition of each of the components comprising the microfluidic cells detailed in the previous embodiments is as follows. It should be understood that the components may comprise any of the materials described herein, as well as other suitable materials. In some cases, the materials for the components may be selected from a list consisting of some or all of the materials described herein. In some cases, one or more of the materials described herein may be specifically excluded for use in a given component or components.

The compression plates 110 and 115 may comprise a rigid material capable of distributing a compressive axial force across the electrochemical cell. Examples of materials may include metals such as steel, stainless steel, aluminum, bronze, titanium. The openings can be formed in the components of the microfluidic cells in any suitable manner including, but not limited to machining, molding, or casting.

The reactor frames 120 and 125 may comprise a chemically compatible material (that is, chemically compatible with the electrolytes) such as: polytetrafluoroethylene (PTFE), polypropylene (PP), high density polyethylene (HDPE), low density polyethylene (LDPE), polyethylene terephthalate (PET), thermoplastic elastomers (TPE), acrylonitrile butadiene styrene (ABS), polycarbonates (PC), polyvinylidene fluoride (PVDF), polyetheretherketone (PEEK), polyphenylene sulfide (PPS), polyvinyl chloride (PVC) or chlorinated polyvinyl-chloride (CPVC).

The elastomeric seals 130 and 135 may comprise a chemically compatible and electrically insulating material such as thermoplastic materials including polytetrafluoroethylene (PTFE), polypropylene, polyurethane, polyimide, MYLAR® biaxially oriented polyethylene terephthalate (BoPET) film, KAPTON® polyimide film, or any combination thereof or elastomeric materials, including, but are not limited to, silicon, nitrile buna, VITON® fluoroelastomer, ethylene propylene diene monomer rubber (EPDM), or any combination thereof.

The anode 211 may comprise graphite or other carbonaceous materials (such as glassy carbon or reticulated vitreous carbon), dimensionally stable anodes (DSA), mixed metal oxides (such as ruthenium oxide (RuO2), iridium oxide (IrO2), tin oxide (SnO2), or lead dioxide (PbO2)), boron doped diamond (BDD), platinum, gold, palladium, lead, nickel, silver, copper, iron, steel, or a combination thereof.

The cathode 231 may comprise one of nickel, boron doped diamond (BDD), graphite or other carbonaceous materials (such as glassy carbon or reticulated vitreous carbon), lead, tin, aluminum, silver, copper, iron, steel, zinc, gold, silver, steel, platinized platinum, or a combination thereof.

The anode 211 and/or the cathode 231 may also comprise a catalytic coating. The catalytic coating may be between 1 μm and 40 μm thick, preferably 10 μm to 20 μm. The catalytic coating may comprise a metal chosen from one or more of the groups of ruthenium (Ru), rhodium (Rh), palladium (Pd), iridium (Ir), platinum (Pt), and tantalum (Ta). The catalytic coasting my consist of a combination of two of the metals from the group of metals listed.

The anode and cathode channeled microfluidic laminae 212/213 and 232/233, respectively, may comprise a thermoplastic or elastomeric material of thicknesses between 1-10 mm, preferably 1 mm. Examples of a thermoplastic material include polytetrafluoroethylene (PTFE), polypropylene, polyurethane, polyimide, MYLAR® biaxially oriented polyethylene terephthalate (BoPET) film, KAPTON® polyimide film, or any combination thereof. Examples of an elastomeric material include, but are not limited to, silicon, nitrile buna, VITON® fluoroelastomer, ethylene propylene diene monomer rubber (EPDM), or any combination thereof.

The ion-permeable membrane 220 may comprise a proton-exchange membrane (PEM) or an anion exchange membrane (AEM). Examples of commercially available PEMs include, but are not limited to, perfluoro sulfonic acid (PFSA). Examples of commercially available AEMs include, but are not limited to, functionalized poly(aryl piperidinium) polymer membranes.

Once an appropriate microfluidic flow electrochemical reactor is constructed and assembled, the power, in the form of a current and voltage, is applied to the anode(s) and cathode(s) as well as the anode solution and cathode solution. Power is delivered to the anode and cathode by connecting at the electrode leads. The power is applied through the cell by means of a potentiostat, galvanostat, or a direct current (DC) power supply. The applied power may be delivered by means of constant potential electrolysis (CPE) or controlled current electrolysis (CCE).

### Examples

The following examples and methods are presented as illustrative of the present invention or methods of carrying out the invention, and are not restrictive or limiting of the scope of the invention in any manner.

In the provided examples, the electrodes have dimensions of 9.869 in by 5.914 in. The channeled microfluidic laminae is designed in-house from PTFE sheets with a thickness of 0.005 in and/or 0.01 in. The volume of the single stack electrochemical reactor measured 3.89 mL for each electrode compartment. The reagents are delivered into the electrochemical cell with Vapourtec peristaltic pumps through ⅛″ diameter FEP tubing, acquired from IDEX. The electrolysis is performed under both potentiostatic and galvanostatic conditions. Prior to the reaction, the microfluidic electrolytic cell is primed with the reagent solutions at their predetermined flow rates for 30 min. While priming the reactor, the current and potential in the electrolytic cell stabilized and reached steady-state condition. After priming the reactor, the solution eluting from the cell containing the product compound is neutralized with 1 M phosphoric acid to a pH of 4-5 and then extracted with chloroform or ethyl acetate. The organic extract is analyzed by GC/MS, GC/FID, and 1H-NMR spectroscopy.

Example 1. Mediated Electrochemical Synthesis of 1,1-Dinitroethane Through Electrolysis of 1-Nitroethane in a Single Compartment Cell An oxidative nitration reaction is used as a model reaction for the microfluidic electrochemical cell 100. The anode and cathode compartments are divided by a 25 μm thick NAFION® N-211 membrane, with an anode compartment of 3.89 mL and a cathode compartment of 3.89 mL in volume. The anode compartment is equipped with a carbon electrode and the cathode compartment with a nickel electrode. Each reagent solution is prepared separately and injected into the reactor using peristaltic pumps. An anode solution containing, 1-nitroethane, sodium hydroxide, sodium nitrite, and sodium ferrocyanide is pumped into the anode compartment. The concentrations of 1-nitroethane, sodium hydroxide, sodium nitrite, and potassium ferrocyanide in the final mixture are 1 M, 1.5 M, 4.0 M, and 0.2 M, respectively. A solution of 2.0 M NaOH is pumped directly into the cathode compartment. Both the anode and cathode compartments are primed for 30 min at a flow rate of 0.4 mL/min and 1.0 mL/min, respectively. The current density is 0.7 A/dm2 , corresponding to a potential of 1.8-2.2 V. The product eluting from the anode compartments is neutralized with a 1 M aqueous solution of H₃PO₄ and extracted with chloroform three times. The chloroform extract is dried over MgSO₄ and concentrated in vacuo. The material is dissolved in deuterated chloroform and analyzed via 1H-NMR spectroscopy. The yield of 1,1-dinitroethane is 90% with a conversion of 100%. 1H-NMR (400 MHz, CDCl3) CH₃CH(NO₂)₂ δ 1.78; (d, 3H, s), 6.2; (q, 1H, br).

### Example 2: Mediated Electrochemical Synthesis of 1,1-Dinitroethane Through Electrolysis of 1-Nitroethane in a Multiple Electrode Compartment Cell.

To demonstrate the ease of scaling within this design, the same reaction is used on the scaled microfluidic electrochemical cell 101. The anode and cathode compartments are divided by a 25 μm thick NAFION® N-211 perfluorosulfonic acid polymer membrane. Each of the anode and cathode compartments had a volume of 3.89 mL. The anode compartments are equipped with carbon electrodes and the cathode compartments with nickel electrodes. Each reagent solution is prepared separately and injected into the reactor using peristaltic pumps. The anode and cathode solutions used in the synthesis are the same as in example 1. Both the anode and cathode compartments are primed for 30 min at a flow rate of 1.2 mL/min and 3.0 mL/min, respectively. The current density is 0.7 A/dm2, corresponding to a potential of 1.8-2.2 V. The product eluting from the anode compartments is neutralized with a 1 M aqueous solution of H₃PO₄ and extracted with chloroform three times. The chloroform extract is dried over MgSO₄ and concentrated in vacuo. The material is dissolved in deuterated chloroform and analyzed via 1H-NMR spectroscopy. The yield of 1,1-dinitroethane is 87% with a conversion of 99%. 1H-NMR (400 MHz, CDCl3) CH₃CH(NO₂)₂ δ 1.78; (d, 3H, s), 6.2; (q, 1H, br).

While the present invention has been illustrated by the description of one or more embodiments thereof, and while the embodiments have been described in considerable detail, they are not intended to restrict or in any way limit the scope of the appended claim to such detail. Additional advantages and modifications will be readily apparent to those skilled in the art. The invention in its broader aspects is therefore not limited to the specific details, representative apparatus and methods and illustrative examples shown and described. Accordingly, departures may be made from such details without departing from the scope or the spirit of the general inventive concept exemplified herein.

What is claimed is:

1. A continuous flow microfluidic electrochemical cell comprising:
a) a first compression plate comprising at least one inlet;
b) a first reactor frame comprising at least one protruding inlet, said first reactor frame being disposed on said first compression plate, said at least one inlet protruding through said at least one inlet of said first compression plate;
c) a first seal comprising at least one inlet, said first seal being disposed on said first reactor frame and said at least one inlet of said first seal being positioned to correspond with the position of said at least one inlet of said reactor frame;
d) an electrochemical cell disposed on said first seal, said electrochemical cell comprising one or more electrode compartments, each electrode compartment comprising at least one inlet and at least one outlet, said one or more electrode compartments being disposed on said first seal and said one or more electrode compartments being arranged, with respect each other when there are at least two electrode compartments, in parallel and/or in series;
e) a second seal comprising at least one outlet, said second seal being disposed on said electrochemical cell and said at least one outlet of said second seal being positioned to correspond with the position of said at least one outlet of said electrochemical cell;
f) a second reactor frame comprising at least one protruding outlet, said second reactor frame being disposed on said second seal and positioned to align said at least one protruding outlet and said at least one outlet of said second seal; and
g) a second compression plate comprising at least one outlet, said second compression plate being disposed on said second reactor frame and positioned to allow said at least one protruding outlet to protrude through said at least one outlet of said second compression plate.

2. The continuous flow microfluidic electrochemical cell of claim 1 comprising multiple electrode compartments, wherein said electrode compartments are in a stacked arrangement.

3. The continuous flow microfluidic electrochemical cell of claim 2 wherein said multiple electrode compartments in a stacked arrangement are configured to direct the flow of electrolytes therethrough in parallel.

4. The continuous flow microfluidic electrochemical cell of claim 2 wherein said multiple electrode compartments in a stacked arrangement are configured to direct the flow of electrolytes therethrough in series.

5. The continuous flow microfluidic electrochemical cell of claim 2 wherein said multiple electrode compartments in a stacked arrangement are configured to direct the flow of electrolytes therethrough in a combination of a parallel configuration and a series configuration.

6. The continuous flow microfluidic electrochemical cell of claim 1 wherein each electrode compartment comprises an anode compartment, a membrane, and a cathode compartment, said membrane being disposed between said anode compartment and said cathode compartment.

7. The continuous flow microfluidic electrochemical cell of claim 6 wherein said anode compartment comprises an anode having at least one inlet, an anode channeled microfluidic flow lamina having at least one inlet and at least one outlet and an anode channeled microfluidic seal lamina having at least one inlet and at least one outlet, said anode channeled microfluidic flow lamina being disposed on said anode and positioned to align said inlet of said anode with said inlet of said anode channeled microfluidic flow lamina, said anode channeled microfluidic seal lamina being disposed on said anode channeled microfluidic flow lamina and positioned to align the at least one inlet of said anode channeled microfluidic flow lamina with said at least one inlet of said anode channeled microfluidic seal lamina, and said at least one outlet of said anode channeled microfluidic flow lamina with said at least one outlet of said anode channeled microfluidic seal lamina.

8. The continuous flow microfluidic electrochemical cell of claim 7 wherein said membrane comprises an ion exchange membrane having at least one inlet and at least one outlet, said membrane being disposed on said anode channeled microfluidic seal lamina and positioned to align said inlet of said anode channeled microfluidic seal lamina with said inlet of said membrane and said outlet of said anode channeled microfluidic seal lamina with said outlet of said membrane.

9. The continuous flow microfluidic electrochemical cell of claim 8 wherein said cathode compartment comprises a cathode having at least one outlet, a cathode channeled microfluidic flow lamina having at least one inlet and at least one outlet and a cathode channeled microfluidic seal lamina having at least one inlet and at least one outlet, said cathode channeled microfluidic flow lamina being disposed on said cathode and positioned to align said inlet of said cathode with said inlet of said cathode channeled microfluidic flow lamina, said cathode channeled microfluidic seal lamina being disposed on said cathode channeled microfluidic flow lamina and positioned to align the at least one inlet of said cathode channeled microfluidic flow lamina with said at least one inlet of said cathode channeled microfluidic seal lamina, and said at least one outlet of said cathode channeled microfluidic flow lamina with said at least one outlet of said cathode channeled microfluidic seal lamina, and said at least one inlet of said cathode channeled microfluidic seal lamina with said at least one inlet of said membrane, and said at least one outlet of said cathode channeled microfluidic seal lamina with said at least one outlet of said membrane.

10. The continuous flow microfluidic electrochemical cell of claim 1 wherein the first and second reactor frames comprise one or more of the following materials:
polytetrafluoroethylene (PTFE), polypropylene (PP), high density polyethylene (HDPE), low density polyethylene (LDPE), polyethylene terephthalate (PET), thermoplastic elastomers (TPE), acrylonitrile butadiene styrene (ABS), polycarbonates (PC), polyvinylidene fluoride (PVDF), polyetheretherketone (PEEK), polyphenylene sulfide (PPS), polyvinyl chloride (PVC), and/or chlorinated polyvinyl-chloride (CPVC).

11. The continuous flow microfluidic electrochemical cell of claim 1 wherein the first and second seals comprise thermoplastic materials, elastomeric materials, or combinations thereof.

12. The continuous flow microfluidic electrochemical cell of claim 11 wherein the first and second seals comprise one or more of the following materials: polytetrafluoroethylene (PTFE), polypropylene, polyurethane, polyimide, biaxially oriented polyethylene terephthalate (BoPET) film, polyimide film, silicon, nitrile buna, fluoroelastomer, ethylene propylene diene monomer rubber (EPDM), or any combination thereof.

13. The continuous flow microfluidic electrochemical cell of claim 9 wherein the anode channeled microfluidic flow lamina, the cathode channeled microfluidic flow lamina, the anode channeled microfluidic seal lamina, and the cathode channeled microfluidic seal lamina comprise thermoplastic materials, elastomeric materials, or combinations thereof.

14. The continuous flow microfluidic electrochemical cell of claim 9 wherein the anode channeled microfluidic flow lamina, the cathode channeled microfluidic flow lamina, the anode channeled microfluidic seal lamina, and the cathode channeled microfluidic seal lamina comprise one or more of the following materials: polytetrafluoroethylene (PTFE), polypropylene, polyurethane, polyimide, biaxially oriented polyethylene terephthalate (BoPET) film, polyimide film, silicon, nitrile buna, fluoroelastomer, ethylene propylene diene monomer rubber (EPDM), or any combination thereof.
